(19) United States
(12) Patent Application Publication
(10) Pub. No.: US 2025/0382816 A1
(43) Pub. Date: Dec. 18, 2025

(54) FABRIC FLOOD PANEL AND FLOOD BARRIER SYSTEM USING SAME

(71) Applicant: BOYNTON BEACH PANEL INC., Lake Worth, FL (US)

(72) Inventor: Brandan Gill, Boynton Beach, FL (US)

(21) Appl. No.: 19/242,450

(22) Filed: Jun. 18, 2025

Related U.S. Application Data
(60) Provisional application No. 63/661,374, filed on Jun. 18, 2024.

(51) Int. Cl. E04H 9/14; B32B 5/02; B32B 15/02; B32B 15/14; E02B 3/10

(52) U.S. Cl. CPC E04H 9/145; B32B 5/02; B32B 15/02; B32B 15/14; E02B 3/106; B32B 2262/0238; B32B 2262/0276; B32B 2262/0284; B32B 2262/14; B32B 2307/7265; B32B 2607/00

(57) ABSTRACT

A short-term flood barrier system uses a fabric panel held in place by angle brackets and gaskets along the ground surface and along the vertical surfaces between which the fabric panel is deployed. The fabric panel includes base sheet of woven polyvinyl chloride and para-aramid fiber. A mesh of wire is affixed to one or both sides of the base sheet. Woven straps are then added to one or both sides of the base sheet over the wire mesh.

### CROSS REFERENCE

This application claims the benefit of U.S. Provisional Patent Application No. 63/661,374, filed Jun. 18, 2024, the entirety of which is hereby incorporated by reference.

### FIELD OF THE INVENTION

The present invention relates generally to flood barrier systems, and, more particularly, relates to panel design for a flood barrier system where the panels form a water barrier.

### BACKGROUND OF THE INVENTION

Flood barrier systems are used to protect buildings in flood prone regions from water intrusion due to weather events and other situations where buildings are likely to be subject to elevated water levels. Flood barriers can be implemented in a variety of forms, including earthen barriers and sandbags. While these forms of barriers may work for some application, they are not so suited for more applications where such barriers are impractical. For example, buildings in urban locations require a different approach, and led to the development of panel barrier systems. A panel barrier is a series of vertically mounted water-impermeable panels that use water resistant gaskets between the panel and concrete surfacing, between adjacent panel, and between the panels and the building side. Thus, these flood panels can be erected similar to a fence around a building that provides a barrier to water. In some applications panels can be mounted across doors and other openings though which water could enter the building. Although very effective, panel systems can occupy a considerable area for storage when not in use. The panels are rigid, and on the order of an inch or more in thickness, and several feet across in both directions (height, width). It would be preferrable to reduce the amount of space needed to store a flood barrier system.

Therefore, a need exists to overcome the problems with the prior art as discussed above.

### SUMMARY

In accordance with some embodiments of the inventive disclosure, there is provided a fabric panel for a flood barrier system that includes a base sheet of a water-impermeable fabric in a rectangular configuration. The base sheet defines a first side and a second side, a first side edge and a second side edge opposite the first side edge, a top edge and a bottom edge that is opposite the top edge. By “defines” it is meant that the base sheet has these features. The fabric panel also has a wire mesh covering and fixed to at least one side of the base sheet.

In accordance with a further feature, the base sheet is made of polycarbonate.

In accordance with a further feature, the base sheet is made of a combination of polyvinyl chloride and poly-paraphenylene terephthalamide fibers.

In accordance with a further feature, the wire mesh is made of titanium wire.

In accordance with a further feature, the wire mesh is a rectangular mesh having a plurality of vertical wire lines that run from the top edge to the bottom edge, and a plurality of horizontal wire lines that run from the first side edge to the second side edge. The plurality of vertical wire lines span a width of the base sheet from the first side edge to the second side edge at a regular horizontal spacing between each of the vertical wire lines. The plurality of horizontal wire lines span a height of the base sheet from the top edge to the bottom edge at a regular vertical spacing between each of the horizontal wire lines.

In accordance with a further feature, the regular horizontal spacing between the vertical wire lines is one half inch to four inches, and the regular vertical spacing between the horizontal wire lines is one half inch to four inches.

In accordance with a further feature, each vertical wire line of the plurality of vertical wire lines comprises a plurality of wires, and each horizontal wire line of the plurality of horizontal wire lines comprises a plurality of wires.

In accordance with a further feature, the fabric panel further includes belting lines along the top edge, bottom edge, first side edge, and second side edge, and a plurality of horizontal belting lines that run from the first side edge to the second side edge between the top edge and the bottom edge.

In accordance with a further feature, the belting lines along the first side edge, second side edge, top edge, bottom edge, and the plurality of horizontal belting lines each comprise a woven nylon belt.

In accordance with a further feature, there is further included a support cable attached to the fabric panel adjacent the top edge, the support cable having a first end at the first side edge and a second end at the second side edge, wherein the first end and the second end are each formed in a loop.

In accordance with some embodiments of the inventive disclosure, there is provided a flood barrier system that includes a horizontal barrier structure configured to be anchored to a horizontal surface, and having a first end and a second end. There is also a first vertical barrier structure that is configured to extend vertically from the first end of the horizontal barrier structure and to be anchored to a first vertical surface. There is also a second vertical barrier structure that is configured to extend vertically from the second end of the horizontal barrier structure and to be anchored to a second vertical surface that is opposite the first vertical surface. There is also a fabric panel having a first side and a second side, a first side edge disposed in the first vertical barrier structure, a second side edge opposite the first side edge that is disposed in the second vertical barrier structure, a top edge, and a bottom edge that is opposite the top edge and disposed in the horizontal barrier structure. The fabric panel also includes a water-impermeable base sheet and a wire mesh covering and fixed to at least one side of the base sheet.

In accordance with a further feature, each of the first vertical barrier structure, the second vertical barrier structure, and the horizontal barrier structure comprise a pair of right-angle brackets, and wherein the fabric panel is disposed between the right-angle brackets of each of the first vertical barrier structure, the second vertical barrier structure, and the horizontal barrier structure.

In accordance with a further feature, the base sheet is made of a combination of polyvinyl chloride and poly-paraphenylene terephthalamide fibers.

In accordance with a further feature, the wire mesh is made of titanium wire.

In accordance with a further feature, the wire mesh is a rectangular mesh has a plurality of vertical wire lines that run from the top edge to the bottom edge, and a plurality of horizontal wire lines that run from the first side edge to the second side edge. The plurality of vertical wire lines span a width of the base sheet from the first side edge to the second side edge at a regular horizontal spacing between each of the vertical wire lines. The plurality of horizontal wire lines span a height of the base sheet from the top edge to the bottom edge at a regular vertical spacing between each of the horizontal wire lines.

In accordance with a further feature, the regular horizontal spacing between the vertical wire lines is one half inch to four inches, and the regular vertical spacing between the horizontal wire lines is one half inch to four inches.

In accordance with a further feature, each vertical wire line of the plurality of vertical wire lines comprises a plurality of wires, and each horizontal wire line of the plurality of horizontal wire lines comprises a plurality of wires.

In accordance with a further feature, there is further included belting lines along the top edge, bottom edge, first side edge, and second side edge, and a plurality of horizontal belting lines that run from the first side edge to the second side edge between the top edge and the bottom edge.

In accordance with a further feature, the belting lines along the first side edge, second side edge, top edge, bottom edge, and the plurality of horizontal belting lines each comprise a woven nylon belt.

In accordance with a further feature, there is further included a support cable attached to the fabric panel adjacent the top edge, the support cable having a first end at the first side edge and a second end at the second side edge, wherein the first end and the second end are each formed in a loop.

Although the invention is illustrated and described herein as embodied in a fabric flood panel, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

“In the description of the embodiments of the present invention, unless otherwise specified, azimuth or positional relationships indicated by terms such as “up”, “down”, “left”, “right”, “inside”, “outside”, “front”, “back”, “head”, “tail” and so on, are azimuth or positional relationships based on the drawings, which are only to facilitate description of the embodiments of the present invention and simplify the description, but not to indicate or imply that the devices or components must have a specific azimuth, or be constructed or operated in the specific azimuth, which thus cannot be understood as a limitation to the embodiments of the present invention. Furthermore, terms such as “first”, “second”, “third” and so on are only used for descriptive purposes, and cannot be construed as indicating or implying relative importance.

In the description of the embodiments of the present invention, it should be noted that, unless otherwise clearly defined and limited, terms such as “installed”, “coupled”, “connected” should be broadly interpreted, for example, it may be fixedly connected, or may be detachably connected, or integrally connected; it may be mechanically connected, or may be electrically connected; it may be directly connected, or may be indirectly connected via an intermediate medium. As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1A is an elevational view of a fabric panel for a flood barrier system, in accordance with some embodiments.

FIG. 1B shows a detail of the construction of the fabric panel for a flood barrier system, in accordance with some embodiments.

FIG. 2A shows an elevational view of a first side of a flood barrier system using a fabric panel, in accordance with some embodiments.

FIG. 2B shows a perspective view of the first side of the flood barrier system using a fabric panel, in accordance with some embodiments.

FIG. 3A shows an elevational view of a second side of a flood barrier system using a fabric panel, in accordance with some embodiments.

FIG. 3B shows a perspective view of the second side of the flood barrier system using a fabric panel, in accordance with some embodiments.

FIG. 4 shows an exploded view of a fastening unit for use in a flood barrier system, in accordance with some embodiments.

FIG. 5 shows a top view of the flood barrier system using a fabric panel, in accordance with some embodiments.

FIG. 6 shows side sectional view of the flood barrier system using a fabric panel, with the section taken centrally through the flood barrier system, in accordance with some embodiments.

FIG. 7 shows a side sectional view detail of the flood barrier system, in accordance with some embodiments.

FIG. 8 shows a top sectional view detail of the flood barrier system, in accordance with some embodiments.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

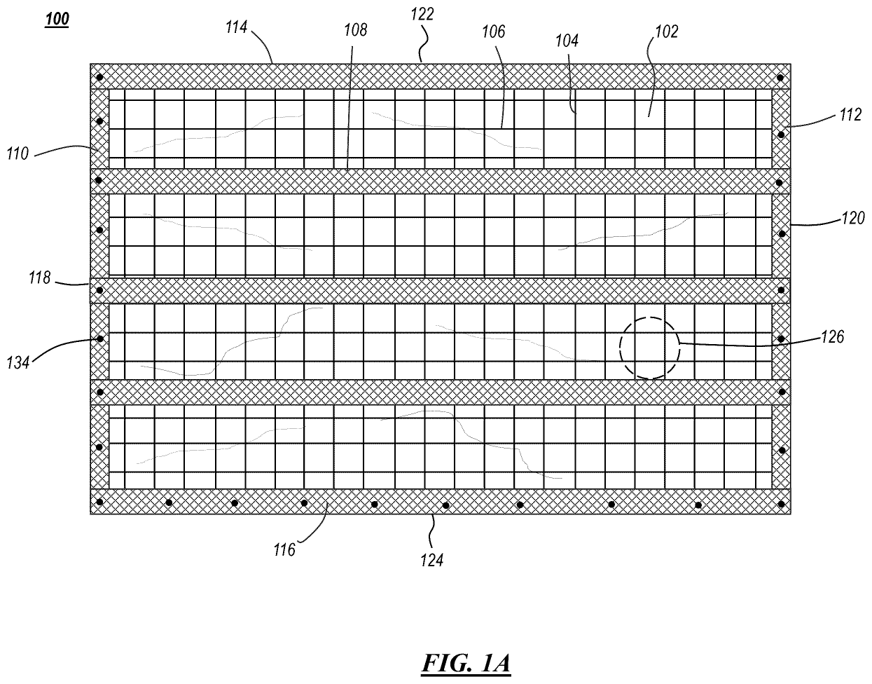

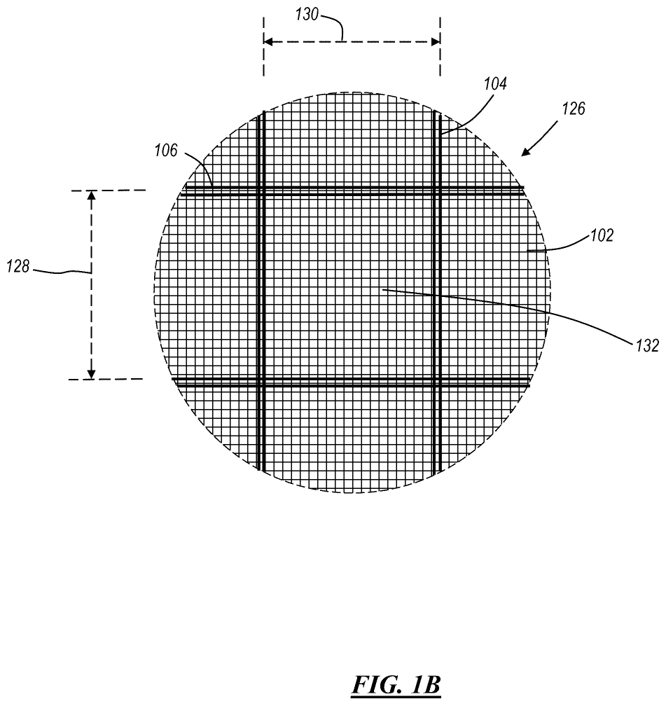

FIG. 1A is an elevational view of a fabric panel 100 for a flood barrier system, in accordance with some embodiments. The fabric panel 100 includes a base sheet 102 of material that is water-impermeable. The fabric panel 100 has a first side (e.g. the side shown here) and a second, opposite, side. The fabric panel 100 also has a first side edge 118, and second side edge 120, a top edge 122, and a bottom edge 124. In general, the fabric panel 100 has a rectangular shape. In some embodiments the fabric panel can have a width from the first side edge 118 to the second side edge 120 of about eight feet, and a height, from the top edge 122 to the bottom edge 124, of about five feet. Of course, different sizes can be used as dictated by particular applications. The fabric panel 100 is intended to span between opposite sides of a throughway, such as, for example, an entrance to a building, or a space between buildings. It is also contemplated that the fabric panel 100 could be used in a series of panels forming an extended barrier wall around a structure. The first and second side edges 118, 120 and the bottom edge 124 are configured to be disposed in respective vertical and horizontal barrier structures. The barrier structures are anchored to surfaces in a water-tight manner, and hold the respective edges of the fabric panel in them in a water-tight manner, thereby creating a flood barrier.

The base sheet 102 is made of a water-impermeable material, such as, for example, polycarbonate. In some embodiments the base sheet can be made of a combination of polyvinyl chloride and poly-paraphenylene terephthalamide fibers. Poly-paraphenylene terephthalamide is known by the trade name KEVLAR, and is a poly-aramid fiber that has good resistance to penetration and cutting, which can resist rupture or tearing of the fabric panel due in response to impact from debris carried by flood waters. The fabric panel 100 can include a wire mesh to provide additional strength and impact resistance. In some embodiments the wire mesh can be a rectangular wire mesh that includes vertical wire lines 104 and horizontal wire lines 106. Each of the wire lines includes at least one wire, and can include a plurality of wires bundled together along the wire line. Thus, as used here, the term “wire line” means at least one wire that forms a line. The wires are made of metal and when more than one wire is present in a wire line, the wires can run parallel to each other in a bundle, or they can be woven or braided together. In some embodiments the wires are made of titanium to provide good strength and low weight. The wire mesh can be fixed onto one or both sides of the fabric panel 100. In some embodiments the wire mesh is disposed only on the “wet” side of the fabric panel, which is the side intended to face the water during a flood event. It is contemplated that in some embodiments a non-rectangular wire mesh can be used, such as, for example, a hexagonal wire mesh. It is further contemplated that, where there is wire mesh on both sides of the base sheet 102, the wire mesh on one side can have a different configuration or arrangement, or the same arrangement as the wire mesh on the opposite side of the base sheet 102. In addition to adding strength to the base sheet, the wire mesh mitigates damage to the fabric panel in the event of a tear or rupture in the base sheet due to debris impact, preventing the tear or rupture from opening further than the local cell formed by the wire mesh in which the tear or rupture occurs. A “cell” being a region of the base sheet surrounded by the wire or wires of the wire mesh.

Detail 126 of FIG. 1A is shown in FIG. 1B, including vertical wire lines 104 and horizontal wire lines 106. Here, the vertical and horizontal wire lines 104, 106 include multiple wires bundled together in each line 104, 106. A cell 132 is shown as a region of the base sheet 102 bounded by wire lines on all sides. When the wire mesh is a rectangular wire mesh, the horizontal spacing 128 and the vertical spacing 130 between wire lines 104, 106 can be one half inch to four inches in some embodiments.

In addition, the wire mesh, the fabric panel 100 can include belting lines of strap material, which can be, for example, woven nylon. There is a first side belting line 110 along the first side edge 118, a second side belting line 112 along the second side edge 120, a top belting line 114 along the top edge 122, and a bottom belting line 116 along the bottom edge 124. There can also be a plurality of horizontal belting lines 108 that run from the first side edge 118 to the second side edge 120. Along the side belting lines 110, 112 and the bottom belting line 116 there can be a plurality of reinforced openings through the belting line material and the base sheet to allow pass through of fasteners for holding the fabric sheet 100 in barrier structures. In some embodiments, the belting lines can have a width of two to three inches, and a horizontal spacing between the horizontal belting lines of five to fifteen inches. In general, the belting lines are fixed to the base sheet along their length, but in some embodiments the horizontal belting lines may only be fixed to the base sheet at the first and second side edges, allowing the horizontal belting lines to move relative to the base sheet between the side edges. As with the wire mesh, the belting line may be provided on one or both sides of the base sheet. In some embodiments the wire mesh and belting lines are provided on the “wet” side of the fabric panel. The horizontal belting lines 108 can add further resistance to damage from debris impact, as larger debris will impact the belting lines, and reduce the impact of the debris against the base sheet and wire mesh.

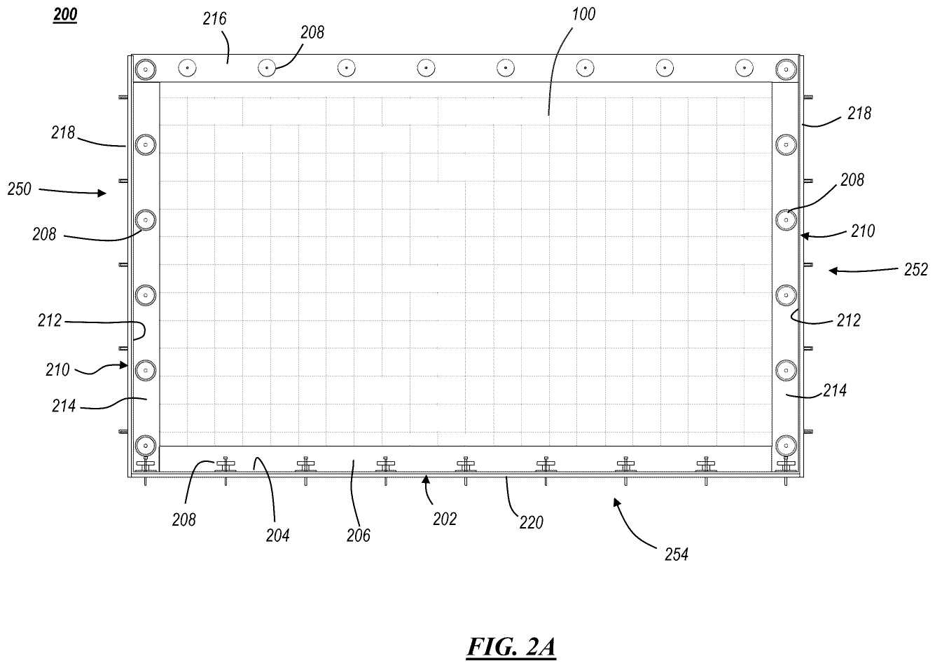

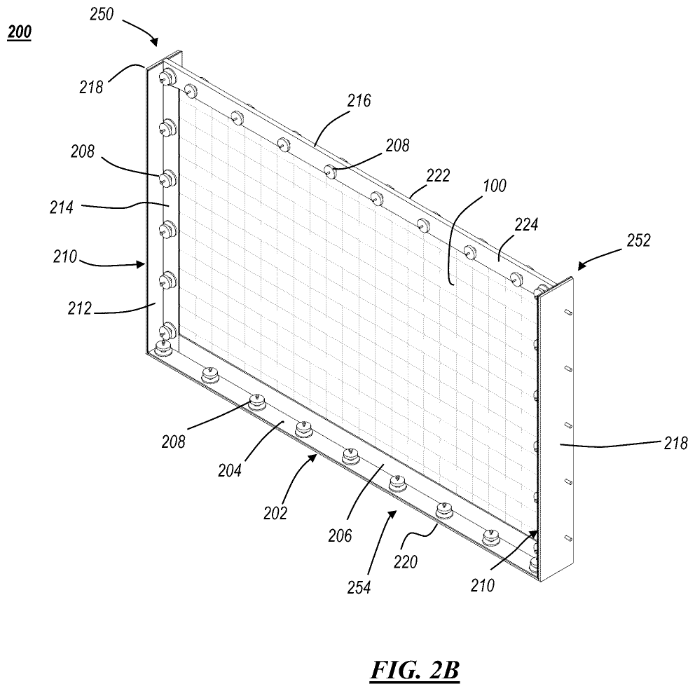

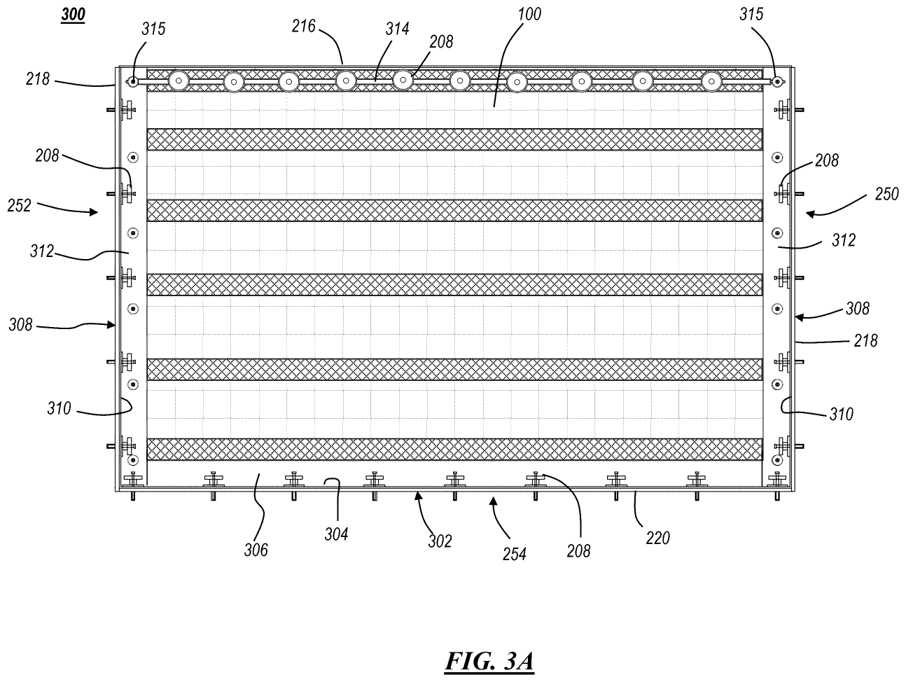

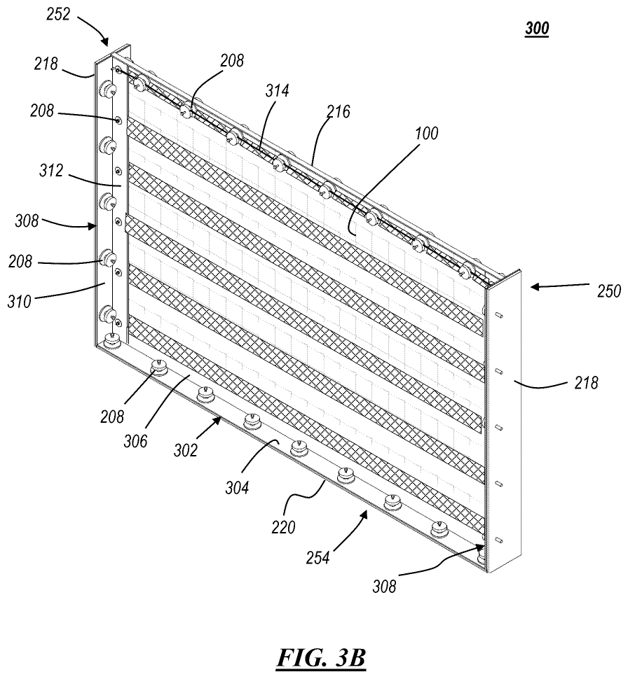

FIG. 2A shows an elevational view of a first side 200 of a flood barrier system using a fabric panel 100, in accordance with some embodiments. FIG. 2B shows the same side in a perspective view. The view of the fabric panel 100 here shows the opposite side from that of FIG. 1A, and it can be seen that there are no belting lines on the side of the fabric panel 100 shown here. The side shown here can be the “dry” side of the fabric panel barrier system, and it is not anticipated that there will be debris impact on the dry side of the barrier, so there is no need for the belting lines. Reference should also be made to FIGS. 3A, 3B, which show the opposite side of the barrier from FIGS. 2A, 2B. The fabric panel 100 is disposed at its side and bottom edges in barrier structures. In particular, the bottom edge of the fabric panel 100 is disposed in a horizontal barrier structure 254, the first side edge of the fabric panel 100 is disposed in a first vertical barrier structure 252, and the second side edge of the fabric panel is disposed in a second vertical barrier structure 250. The barrier structures 250, 252, 254 are configured to be anchored to a respective surface. In particular a cementitious surface, such as concrete, or similar construction materials. In particular the horizontal barrier structure 254 is configured to be anchored to a horizontal surface, such as concrete around or adjacent a building. The vertical barrier structures 250, 252 are configured to be anchored to vertical surfaces, such as exterior walls of a building or buildings. Each of the vertical barrier structures 250, 252 extend from an opposite end of the horizontal barrier structure 254.

In some embodiments the barrier structures 250, 252, 254 can be comprised of a pair of right-angle brackets that each have an anchoring portion for anchoring to their respective anchor surface, and a capture portion at a right-angle to the anchoring portion that opposes the capture portion of the opposing right-angle bracket of the respective barrier structure and holds an edge of the fabric panel therebetween. The right-angle brackets can be made of aluminum, or another sufficiently rigid material. For example, the horizontal barrier structure includes a first horizontal right-angle bracket 202, and a second horizontal right-angle bracket 302. Likewise, the first vertical barrier structure 252 and the second vertical barrier structure each include a first vertical right-angle bracket 210 and a second vertical right-angle bracket 308. The first horizontal right-angle bracket 202 includes an anchor portion 204 and a capture portion 206 and the second horizontal right-angle bracket 302 includes an anchor portion 304 and capture portion 306. The anchor portions 204, 304 and the capture portions 206, 306 provide a generally flat surface on each side of the respective portions 204, 304, 206, 306. The bottom side of the anchor portions 204, 304 bear against a bottom gasket 220. To anchor the horizontal right-angle brackets to the ground surface, there are a plurality of fastening units 208 which include a bolt that passes through the anchor portions 204, 304 and the gasket 220 and into a respective corresponding anchor disposed in the ground surface. The fastening units 208 can be tightened against the anchor in the ground surface to compress the gasket 220 and create a water-tight seal against the ground surface.

Similarly, each of the vertical right-angle brackets 210, 308 each have an anchor portion 212, 310 and a capture portion 214, 312, respectively. The anchor portions 212, 310 bear against a gasket 218 that is positioned between the anchor portion 212, 310 and the wall/surface to which the vertical right-angle brackets 210, 308 are anchored. Fastening units 208 are used to anchor the anchor portions 212, 310 to the wall/surface in the same manner as the horizontal right-angle brackets are anchored to the ground surface. It should be noted that in the context of anchoring, the term “surface” means the structure to which the bracket is being anchored, including the planar exterior surface as well as the material of the structure past the surface in which anchors are embedded to interface with the fastening units 208. The capture portions 214, 312 bear against the respective side edge of the fabric panel 100 and a gasket to capture and seal the fabric panel 100 between the capture portions 214, 312 of the opposing right-angle brackets 210, 308. The fastening units 208 used in the capture portions 204, 304, 212, 310 pass through both opposing capture portions (e.g. 204 and 304, and 212, and 310) as well as the fabric panel, such as through the reinforced openings 134.

In some embodiments a top cap 216 can be provided along the top edge 122 of the fabric panel. The top cap 216 is a rigid member having a horizontal portion 222 that extends over the top of the fabric panel 100, and a vertical portion 224 at a right-angle to the horizontal portion 222 that runs along the side of the fabric panel 100 adjacent the top edge 122. The top cap provides support and rigidity to the top of the fabric panel 100. Further, a cable 314 can be disposed on the opposite side of the fabric panel 100 from the vertical portion 224 of the top cap 216. The cable 314 extends across the entire width of the fabric panel along or adjacent to the top edge 122, and can have ends that are loops 315 to assist in hanging the fabric panel 100 during assembly of the flood barrier system.

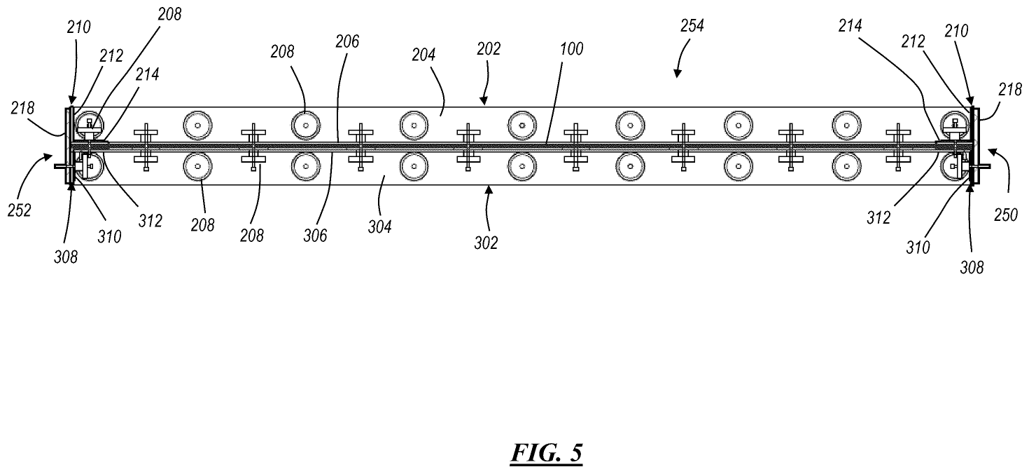

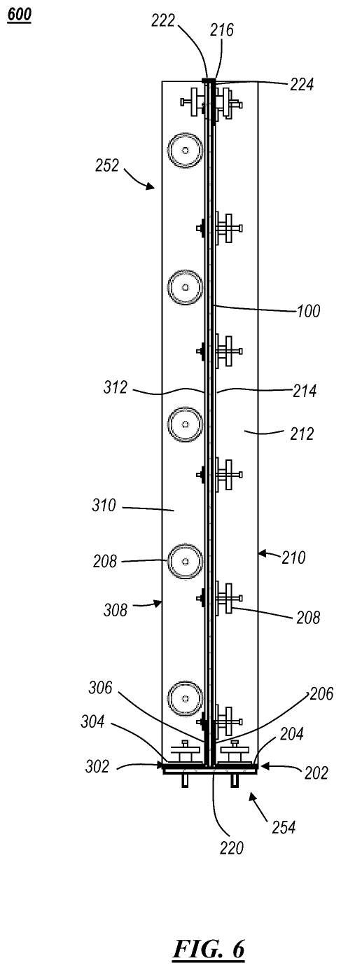

FIG. 5 shows a top view of the flood barrier system using a fabric panel 100, in accordance with some embodiments. The horizontal barrier structure 254 is comprised of first and second horizontal right-angle brackets 202, 302, which has opposing capture portions 206, 306, between which the bottom edge of the fabric panel 100 is disposed and captured. The vertical right-angle brackets 210, 308 at each side of the barrier system are also shown, and it can be seen that the respective side edges of the fabric panel are captured between opposing capture portions 214, 312 of the vertical right-angle brackets 210, 308 at each side of the fabric panel 100. Fastening units 208 are used to both anchor the brackets to the respective surfaces, and to each other to capture the fabric panel 100 between their respective capture portions, as well as to attach the top cap 216 to the system. FIG. 6 shows a side sectional view of the flood barrier system using a fabric panel 100, with the section taken centrally through the flood barrier system, in accordance with some embodiments. As in FIG. 5, the various brackets 202, 320, 210, 308 are shown. The opposing capture portions 206, 306 of the horizontal angle brackets 202, 302 are shown with the bottom edge of the fabric panel captured therebetween. Likewise, the capture portions 214, 312 of the vertical angle brackets 210, 308 capture the side edge of the fabric panel therebetween. In general, the barrier structures 250, 252, and 254 are anchored to respective surfaces using a plurality of fastening units that mate with embedded anchors in the respective surfaces. These fastening units used for anchoring also compress respective gaskets between the angle brackets and the surfaces to form seals that prevent water egress. Similarly, the barrier structures capture the side and bottom edges of the fabric panel 100 in a water-tight manner. The fastening units 208 are also used to compress the capture portions of the opposing angle brackets together with the fabric panel edges between the capture portions.

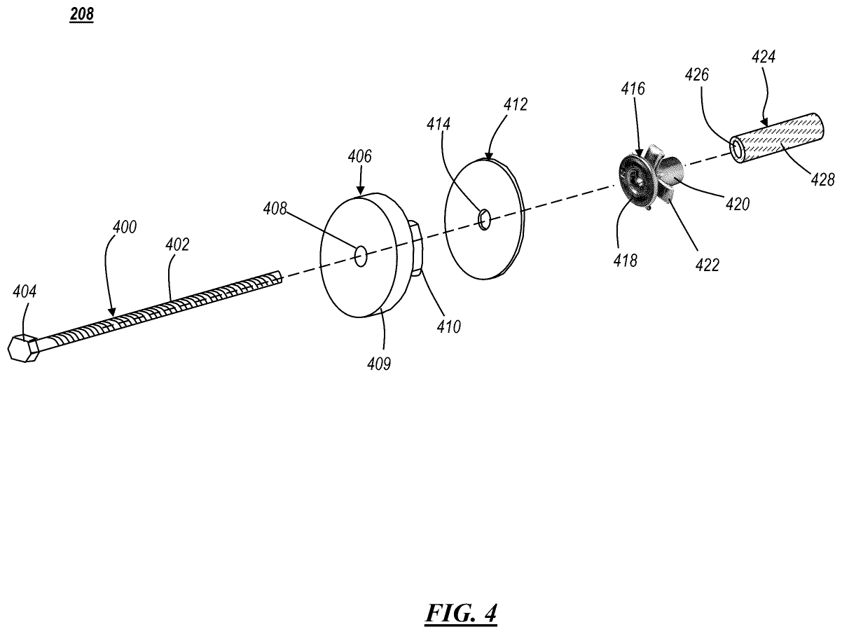

FIG. 4 shows an exploded view of a fastener unit 208 for use with the inventive flood panel barrier system support structure, in accordance with some embodiments. The fastener unit 208 includes a bolt 400 which can be a tap bolt. The bolt 400 includes a threaded shank 402 and a head 404 that can be a hex-head, as is well known. An adjustment knob 406 has a threaded through-hole 408 to allow the adjustment knob 406 to thread onto the shank 402 of the tap bolt 400. The main body 409 is puck-shaped and can be knurled or fluted around the outside edge to allow for turning the knob 406. The knob 406 further includes a standoff 410 that can also be puck-shaped, with have smaller diameter than the main body 409, and through which the threaded hole 408 also passes. The bottom of the standoff portion 410 of the knob 406 bears against a washer 412 to exert a compressive force, which has an opening 414 that is slightly larger than the outside diameter of the shank 402 of the bolt 400. Thus, the shank 402 can pass through the washer 412 without having to be threaded through the washer 412. The washer 412 can be a dock washer and have a diameter of about three inches in some embodiments. The bolt 400 can have a length of four to six inches, such as a ⅜″×4″ tap bolt. The knob 406 and washer 412 are positioned on the outward facing side of the support structure so that personnel can easily access and tighten or loosen the knobs 406 of each fastener unit 208. The bolt shank 402 passes through support bracket, gasket, and/or the fabric panel, depending on where it is located. The distal end of the shank 402 threads into either a rivet nut 416 or an anchor 424, depending on the location of the fastening unit 208, and in some positions the distal end of the shank 402 can instead be threaded into an opposing knob 406. The rivet nut 416 includes a threaded body 420 into which the shank 402 is threaded. A flange 418 extends outward and acts like a washer. There is a collapsible portion 422 that collapses when the bolt is tightened while the flange 418 is bearing against a surface, causing sections of the collapsible portion 422 to collapse and extend outward. The anchor 424 can be a snake anchor and is intended to fit into a bore, such as a bore into the ground surface, and frictionally engage the sides of the bore so as to become stuck fast in the bore. This can occur, for example, by making the inner diameter of the axial bore 426 of the anchor 424 slightly smaller than the outside diameter of the shank 402 of the bolt 400, and the outside diameter of the body 428 of the anchor about the same as the diameter of the bore into which the anchor 424 is sunk. Thus, when the bolt 400 is threaded into the axial bore 426, it will force the body 428 outward against the wall of the bore in which the anchor 424 is sunk. Fastening units that secure the fabric panel to the vertical support members of the vertical portion of angled plates can be referred to as panel fastening units and use the rivet nut 316. Fastening unit that secure the horizontal portion of angled plates to the ground or throughway walls can be referred to a ground or plate fastening units and use an anchor 424.

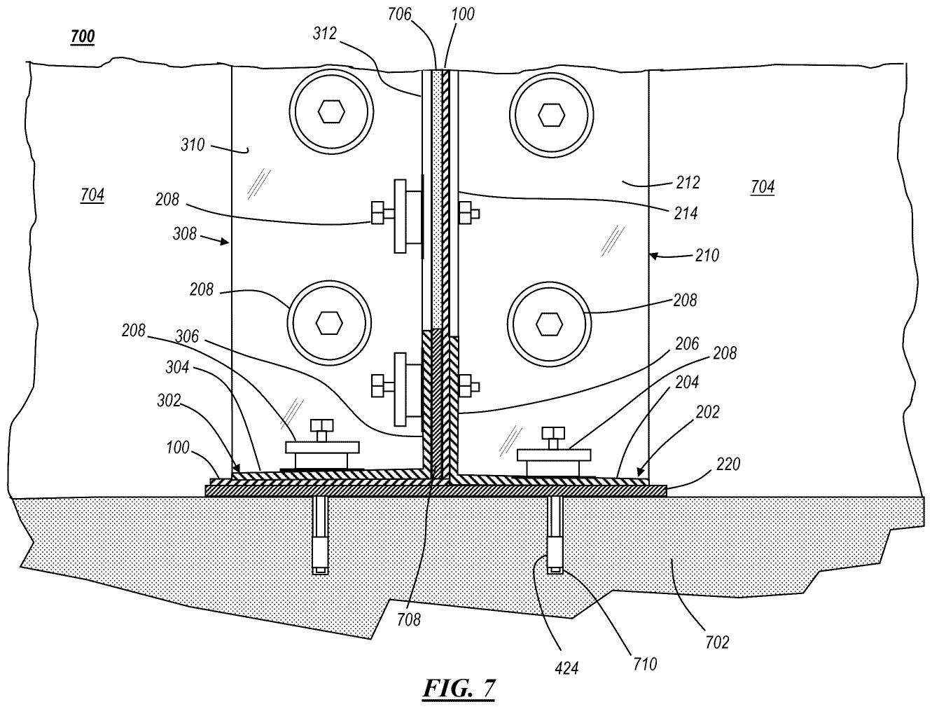

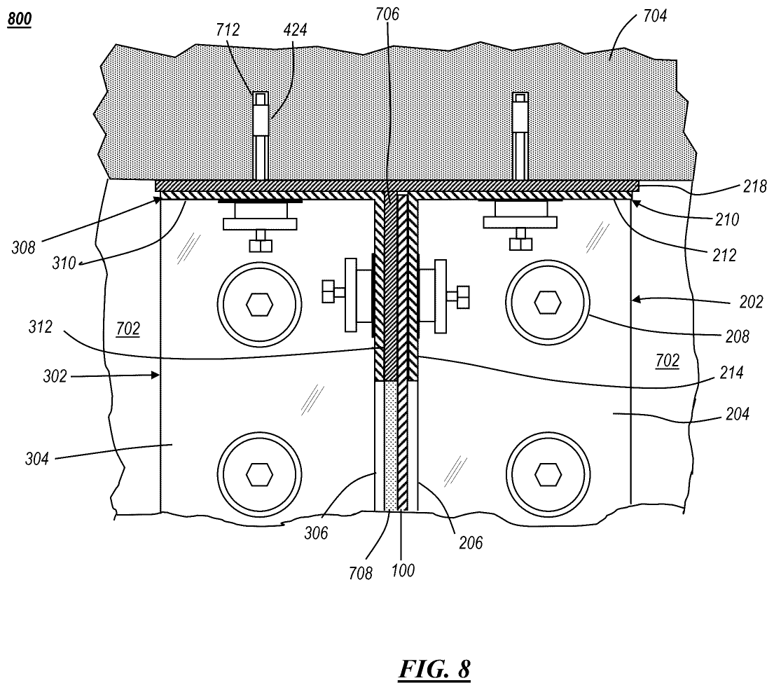

FIG. 7 shows a side sectional view detail 700 of the flood barrier system, in accordance with some embodiments. Similar to FIG. 6, the view detail 700 shows the lower portion of the barrier system. There is a ground surface 702, into which the bolts of fastening units 208 extend into anchors 424 embedded in bores 710 into the ground surface 702. The ground surface 702 is preferrable cementitious, such as concrete, or another suitable anchoring surface that will resist being pulled up in response to the force of water against the flood barrier system. The vertical angle brackets 210, 308 bear against a vertical surface 704. FIG. 8 shows top sectional view detail 800 with the section taken centrally in the horizontal direction. In FIG. 8, it can be seen that the vertical angle brackets 210, 308 bear against the vertical surface 704 with fastening units 208 mated with anchors 424 in bores 712 in the vertical surface 704. In FIG. 7, the bottom gasket 220 can be seen disposed between the anchor portions 204, 304 of the horizontal angle brackets 202, 302. In addition, there can be seen a vertical gasket 706 between the capture portions 214, 312 of the vertical angle brackets 210, 308, and a horizontal gasket 708 between the capture portions 206, 306 of the horizontal angle brackets 202, 302. Either the horizontal gasket 708 can extend completely across the barrier system in the horizontal direction, with the vertical gaskets 706 on top at the side, and extending upwards, or the vertical gaskets 706 can extend to the ground or to the bottom gasket 220, with the horizontal gasket 708 between them. The arrangement of gaskets is such that they abut each other so that when compressed by the anchor portions, the gaskets also seal against each other.

The disclosed flood panel barrier system using a fabric panel that is lighter than prior art rigid flood panels, and can be easier to manufacture and store when not in use. The fabric panels, when folded, are generally no thicker than a conventional rigid flood panel, and being folded, take up much less space. This can allow the fabric flood panels to be stored in groups in boxes, for example. When deploying the barrier system, it is easier for one person to set up the barrier system. For example, vertical angle brackets 308 and side gaskets 218 can be set up against the opposing vertical surfaces, and the second horizontal right-angle bracket 302 and bottom gasket 220 can be set up on the ground surface. The anchor bores and anchors, having been previously placed, it is simply a matter of installing the fastening units to anchor the right-angle brackets 302, 308 in place. Then the vertical and horizontal gaskets 706, 708 can be placed, with fasting units extending through the capture portions 306, 312 of the anchored right-angle brackets 302, 308. Then the fabric panel can be installed, hanging the cable loops 315 on the top-most fastening units in the capture portion 310 of the vertical angle brackets 308. Then the reinforced openings 134 are each passed over the bolt of a respective fastening unit along the vertical and horizontal angle brackets 302, 308, at which point the fabric panel 100 is in place, and the opposing horizontal and vertical angle brackets 202, 210 can be installed, capturing the fabric panel 100 and gaskets 706, 708 between the corresponding capture portions 206, 306, and 214, 312. Once the angle brackets 202, 210 are in place, further fastening units 208 are installed to anchor angle brackets 202, 210, and then the fastening units 208 in the capture portions 206, 306 and 214, 312 can be tightened to compress the gaskets 706, 708 and seal the barrier system. Top cap 216 can also be installed during or after this process.

What is claimed is:

1. A fabric panel for a flood barrier system, comprising:
a base sheet of a water-impermeable fabric in a rectangular configuration and defining a first side and a second side, a first side edge and a second side edge opposite the first side edge, a top edge and a bottom edge that is opposite the top edge; and
a wire mesh covering and fixed to at least one side of the base sheet.

2. The fabric panel of claim 1, wherein the base sheet is made of polycarbonate.

3. The fabric panel of claim 1, wherein the base sheet is made of a combination of polyvinyl chloride and poly-paraphenylene terephthalamide fibers.

4. The fabric panel of claim 1, wherein the wire mesh is made of titanium wire.

5. The fabric panel of claim 4, wherein the wire mesh is a rectangular mesh having:
a plurality of vertical wire lines that run from the top edge to the bottom edge, and a plurality of horizontal wire lines that run from the first side edge to the second side edge;
the plurality of vertical wire lines span a width of the base sheet from the first side edge to the second side edge at a regular horizontal spacing between each of the vertical wire lines; and
the plurality of horizontal wire lines span a height of the base sheet from the top edge to the bottom edge at a regular vertical spacing between each of the horizontal wire lines.

6. The fabric panel of claim 5, wherein the regular horizontal spacing between the vertical wire lines is one half inch to four inches, and the regular vertical spacing between the horizontal wire lines is one half inch to four inches.

7. The fabric panel of claim 5, wherein each vertical wire line of the plurality of vertical wire lines comprises a plurality of wires, and each horizontal wire line of the plurality of horizontal wire lines comprises a plurality of wires.

8. The fabric panel of claim 1, further comprising belting lines along the top edge, bottom edge, first side edge, and second side edge, and a plurality of horizontal belting lines that run from the first side edge to the second side edge between the top edge and the bottom edge.

9. The fabric panel of claim 8, wherein the belting lines along the first side edge, second side edge, top edge, bottom edge, and the plurality of horizontal belting lines each comprise a woven nylon belt.

10. The fabric panel of claim 1, further comprising a support cable attached to the fabric panel adjacent the top edge, the support cable having a first end at the first side edge and a second end at the second side edge, wherein the first end and the second end are each formed in a loop.

11. A flood barrier system, comprising:
a horizontal barrier structure configured to be anchored to a horizontal surface, and having a first end and a second end;
a first vertical barrier structure that is configured to extend vertically from the first end of the horizontal barrier structure and to be anchored to a first vertical surface;
a second vertical barrier structure that is configured to extend vertically from the second end of the horizontal barrier structure and to be anchored to a second vertical surface that is opposite the first vertical surface; and
a fabric panel having a first side and a second side, a first side edge disposed in the first vertical barrier structure, a second side edge opposite the first side edge that is disposed in the second vertical barrier structure, a top edge, and a bottom edge that is opposite the top edge and disposed in the horizontal barrier structure, the fabric panel comprising a water-impermeable base sheet and a wire mesh covering and fixed to at least one side of the base sheet.

12. The flood barrier system of claim 11, wherein each of the first vertical barrier structure, the second vertical barrier structure, and the horizontal barrier structure comprise a pair of right-angle brackets, and wherein the fabric panel is disposed between the right-angle brackets of each of the first vertical barrier structure, the second vertical barrier structure, and the horizontal barrier structure.

13. The flood barrier system of claim 11, wherein the base sheet is made of a combination of polyvinyl chloride and poly-paraphenylene terephthalamide fibers.

14. The flood barrier system of claim 11, wherein the wire mesh is made of titanium wire.

15. The flood barrier system of claim 14, wherein the wire mesh is a rectangular mesh having:
a plurality of vertical wire lines that run from the top edge to the bottom edge, and a plurality of horizontal wire lines that run from the first side edge to the second side edge;
the plurality of vertical wire lines span a width of the base sheet from the first side edge to the second side edge at a regular horizontal spacing between each of the vertical wire lines; and
the plurality of horizontal wire lines span a height of the base sheet from the top edge to the bottom edge at a regular vertical spacing between each of the horizontal wire lines.

16. The flood barrier system of claim 15, wherein the regular horizontal spacing between the vertical wire lines is one half inch to four inches, and the regular vertical spacing between the horizontal wire lines is one half inch to four inches.

17. The flood barrier system of claim 15, wherein each vertical wire line of the plurality of vertical wire lines comprises a plurality of wires, and each horizontal wire line of the plurality of horizontal wire lines comprises a plurality of wires.

18. The flood barrier system of claim 11, further comprising belting lines along the top edge, bottom edge, first side edge, and second side edge, and a plurality of horizontal belting lines that run from the first side edge to the second side edge between the top edge and the bottom edge.

19. The flood barrier system of claim 18, wherein the belting lines along the first side edge, second side edge, top edge, bottom edge, and the plurality of horizontal belting lines each comprise a woven nylon belt.

20. The flood barrier system of claim 11, further comprising a support cable attached to the fabric panel adjacent the top edge, the support cable having a first end at the first side edge and a second end at the second side edge, wherein the first end and the second end are each formed in a loop.
